(19) United States
(12) Patent Application Publication
(10) Pub. No.: US 2024/0313922 A1
(43) Pub. Date: Sep. 19, 2024

(54) METHOD AND DEVICE FOR ALLOCATING RESOURCES IN COMMUNICATION SYSTEM USING MULTI-PANEL ANTENNA

(71) Applicants: HYUNDAI MOTOR COMPANY, Seoul (KR); KIA CORPORATION, Seoul (KR); SEOUL NATIONAL UNIVERSITY R&DB FOUNDATION, Seoul (KR)

(72) Inventors: Gene Back Hahn, Hwaseong-si (KR); Young Kil Suh, Hwaseong-si (KR); Ui Hyun Hong, Hwaseong-si (KR); Bum Jun Kim, Seoul (KR); Jeonghyeon Kwon, Seoul (KR); Wan Choi, Seoul (KR)

(73) Assignees: HYUNDAI MOTOR COMPANY, Seoul (KR); KIA CORPORATION, Seoul (KR); SEOUL NATIONAL UNIVERSITY R&DB FOUNDATION, Seoul (KR)

(21) Appl. No.: 18/647,794

(22) Filed: Apr. 26, 2024

Related U.S. Application Data
(63) Continuation of application No. PCT/KR2022/016502, filed on Oct. 26, 2022.

(30) Foreign Application Priority Data
Oct. 26, 2021 (KR) 10-2021-0143817

(51) Int. Cl. H04L 5/00; H04W 24/10; H04W 76/20

(52) U.S. Cl. CPC H04L 5/0051; H04W 24/10; H04W 76/20

(57) ABSTRACT

The present disclosure is a method for operating a first communication node in a communication system, comprising the steps of: transmitting a reference signal at predetermined intervals through each panel included in a multi-panel antenna of the first communication node, wherein the reference signal includes each panel index; receiving a measurement report corresponding to each panel from a second communication node, wherein the measurement report includes the panel index and a received signal received power value of a reference signal corresponding to the panel index; selecting a panel to be allocated to the second communication node on the basis of the measurement report; and transmitting a response signal including information on the selected panel to the second communication node.

### TECHNICAL FIELD

The present disclosure relates to a method and an apparatus for resource allocation in a communication system, and more particularly, to a method and an apparatus for resource allocation in a communication system using a multi-panel antenna.

### BACKGROUND ART

With the development of information and communication technology, various wireless communication technologies have been developed. Typical wireless communication technologies include long term evolution (LTE), new radio (NR), 6th generation (6G) communication, and/or the like. The LTE may be one of 4th generation (4G) wireless communication technologies, and the NR may be one of 5th generation (5G) wireless communication technologies.

In order to process rapidly increasing wireless data, the 5G (or NR) communication or subsequent wireless communication technologies can support communication in relatively high frequency bands. For example, radio frequency bands used for wireless communication in the 5G (or NR) communication specifications may be broadly classified into frequency range 1 (FR1) bands and frequency range 2 (FR2) bands. Here, the FRI bands may refer to relatively low frequency bands as compared to the FR2 bands, which are of about 7 GHz or below. The FR2 bands may refer to relatively high frequency bands as compared to the FR1 bands, which are of about 7 GHz or above. The FR2 bands may be 28-29 GHz bands, which include unlicensed bands, millimeter wave bands, and terahertz wave bands.

In the 5G (or NR) communication system, a carrier bandwidth is defined as up to 100 MHz in FR1 and up to 400 MHz in FR2. Since the 5G (or NR) communication system requires a further increase in carrier bandwidth compared to the maximum bandwidth 20 MHz supported by the LTE system, there is a possibility that it may not be able to support the entire carrier bandwidth of up to 400 MHz depending on a power and computing capability of a terminal. Accordingly, in the 5G (or NR) specifications, some continuous resource blocks within the carrier bandwidth are defined and used as a bandwidth part (BWP). A BWP may be defined to have a different center frequency, bandwidth, and numerology for each terminal, and one terminal can activate only one BWP within a single carrier bandwidth.

In the 5G (or NR) standardization meeting, research is being actively conducted to utilize a wide frequency band in the FR2 band, which is a relatively high frequency band. However, the current 5G (or NR) specifications have no technical decisions on how to flexibly operate a wide frequency band depending on a situation.

Meanwhile, the technologies that are the background of the present disclosure are written to improve the understanding of the background of the present disclosure and may include content that is not already known to those of ordinary skill in the art to which the present disclosure belongs.

### DISCLOSURE

### Technical Problem

The present disclosure provides a procedure and an apparatus for providing more efficient communication by selecting panel(s) in a communication system having a multi-panel antenna. Further, the present disclosure provides a method and an apparatus capable of increasing resource utilization efficiency in the communication system when selecting or reselecting panel(s).

### Technical Solution

A method according to the present disclosure, as an operation method of a first communication node in a communication system, may comprise: transmitting a reference signal at a predetermined periodicity through each of panels included in a multi-panel antenna of the first communication node, the reference signal including each panel index; receiving a measurement report corresponding to each of the panels from a second communication node, the measurement report including a panel index and a received signal received power value of the reference signal corresponding to the panel index; selecting a panel to be allocated to the second communication node based on the measurement report; and transmitting a response signal including information on the selected panel to the second communication node.

The response signal may be transmitted through all panels included in the multi-panel antenna, a panel selected based on the measurement report among the panels included in the multi-panel antenna, at least one panel selected among the selected panel and an arbitrary panel, or at least one arbitrary panel.

The response signal may be one of a radio resource control (RRC) message, an RRC reconfiguration message, or a response message corresponding to the measurement report.

In the selecting of the panel to be allocated to the second communication node, the panel may be selected considering measurement information received from a third communication node and a subcarrier spacing (SCS) to be used for communication of the second communication node and the third communication node.

In the selecting of the panel to be allocated to the second communication node, the panel may be selected considering measurement information received from a third communication node and a bandwidth part (BWP) inactivity timer value to be used for communication of the second communication node and the third communication node.

In the selecting of the panel to be allocated to the second communication node, the panel may be selected considering measurement information received from a third communication node and a BWP switch delay value to be used for communication of the second communication node and the third communication node.

In the selecting of the panel to be allocated to the second communication node, the panel may be selected considering two or more among measurement information received from a third communication node, an SCS to be used for communication of the second communication node and the third communication node, or a BWP inactivity timer value or a BWP switch delay value to be used for communication of the second communication node and the third communication node.

The method may further comprise: in response to receiving, from the second communication node, a measurement report including a reallocation request indicator for an allocated BWP and/or the selected panel while communicating with the second communication node through the allocated BWP and the selected panel, reselecting a panel to use for communication based on the panel index and the received signal receiver power value of the reference signal corresponding to the panel index, which are included in the received measurement report.

An apparatus according to an exemplary embodiment of the present disclosure, as a first communication node apparatus in a communication system, may comprise: a transceiver configured to transmit and receive signals with at least one second communication node; and at least one processor, and the at least one processor may be executed to: control the transceiver to transmit a reference signal at a predetermined periodicity through each of panels included in a multi-panel antenna of the first communication node, the reference signal including each panel index; control the transceiver to receive a measurement report corresponding to each of the panels from the at least one second communication node, the measurement report including a panel index and a received signal received power value of the reference signal corresponding to the panel index; select a panel to be allocated to the at least one second communication node based on the measurement report; and control the transceiver to transmit a response signal including information on the selected panel to the second communication node.

The response signal may be transmitted through all panels included in the multi-panel antenna, a panel selected based on the measurement report among the panels included in the multi-panel antenna, at least one panel selected among the selected panel and an arbitrary panel, or at least one arbitrary panel.

The response signal may be one of a radio resource control (RRC) message, an RRC reconfiguration message, or a response message corresponding to the measurement report.

The at least one processor may be executed to, in the selecting of the panel to be allocated to the second communication node, select the panel considering measurement information received from a third communication node and a subcarrier spacing (SCS) to be used for communication of the second communication node and the third communication node.

The at least one processor may be executed to, in the selecting of the panel to be allocated to the second communication node, select the panel considering measurement information received from a third communication node and a bandwidth part (BWP) inactivity timer value to be used for communication of the second communication node and the third communication node.

The at least one processor may be executed to, in the selecting of the panel to be allocated to the second communication node, select the panel considering measurement information received from a third communication node and a BWP switch delay value to be used for communication of the second communication node and the third communication node.

The at least one processor may be executed to, in the selecting of the panel to be allocated to the second communication node, select the panel considering two or more among measurement information received from a third communication node, an SCS to be used for communication of the second communication node and the third communication node, or a BWP inactivity timer value or a BWP switch delay value to be used for communication of the second communication node and the third communication node.

The at least one processor may be executed to, in response to receiving, from the second communication node, a measurement report including a reallocation request indicator for an allocated BWP and/or the selected panel while communicating with the second communication node through the allocated BWP and the selected panel, reselect a panel to use for communication based on the panel index and the received signal receiver power value of the reference signal corresponding to the panel index, which are included in the received measurement report.

A method according to another exemplary of the present disclosure, as an operation method of a first communication node in a communication system, may comprise: receiving a reference signal at a predetermined periodicity through each of panels included in a multi-panel antenna of a second communication node to communicate, the reference signal including each panel index; measuring a received power for the reference signal received through each of the panels; transmitting, to the second communication node, a measurement report including an index of each of the panels and information on the received power corresponding to each of the panels; receiving, from the second communication node, information on a selected panel in response to the measurement report; obtaining additional information for communicating with the second communication node through the selected panel; and communicating with the second communication node using the selected panel and the additional information.

The additional information may include information on a bandwidth part (BWP) to be used for communication with the second communication node through the selected panel.

The method may further comprise: measuring a received power for the reference signal received through each of the panels when the BWP to be used for communication with the second communication node is unusable; and transmitting a second measurement report including an indicator requesting reallocation of a BWP and/or panel to the second communication node.

The method may further comprise: receiving, from the second communication node, information on a changed panel and BWP reallocation information; and communicating with the second communication node based on the information on the changed panel and the BWP reallocation information.

### Advantageous Effects

When applying the apparatus and method according to the present disclosure, more efficient communication becomes possible through panel selection in a communication system with a multi-panel antenna. Further, according to the present disclosure, the resource utilization efficiency of the communication system can be increased when selecting or reselecting panel(s).

### DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3A is a diagram illustrating a massive antenna structure according to a single-panel antenna structure.

FIG. 3B is a diagram illustrating a structure of a plurality of panel antennas according to a multi-panel antenna structure.

FIG. 4 is a signal flow diagram describing selection for a multi-panel antenna based on signal measurements between communication devices according to the present disclosure.

FIG. 5 is a signal flow diagram describing panel selection and communication during BWP adaptation according to another exemplary embodiment of the present disclosure.

FIG. 6 is a signal flow diagram describing a process for panel and BWP reallocation depending on a channel environment between a terminal and a base station according to an exemplary embodiment of the present disclosure.

FIG. 7 is a diagram describing a panel and BWP allocation and reallocation procedure according to the present disclosure.

### MODE FOR INVENTION

While the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, B5G mobile communication network (6G communication network, etc.), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

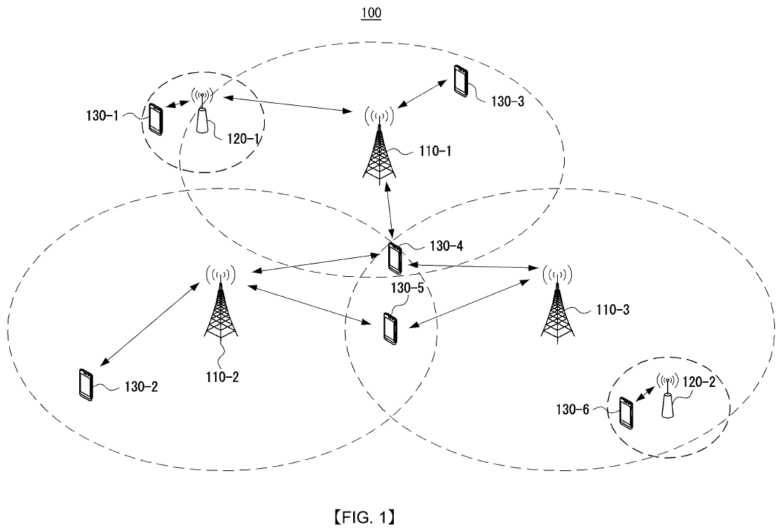

FIG. 1 is a conceptual diagram illustrating an exemplary embodiment of a communication system.

As shown in FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have the following structure.

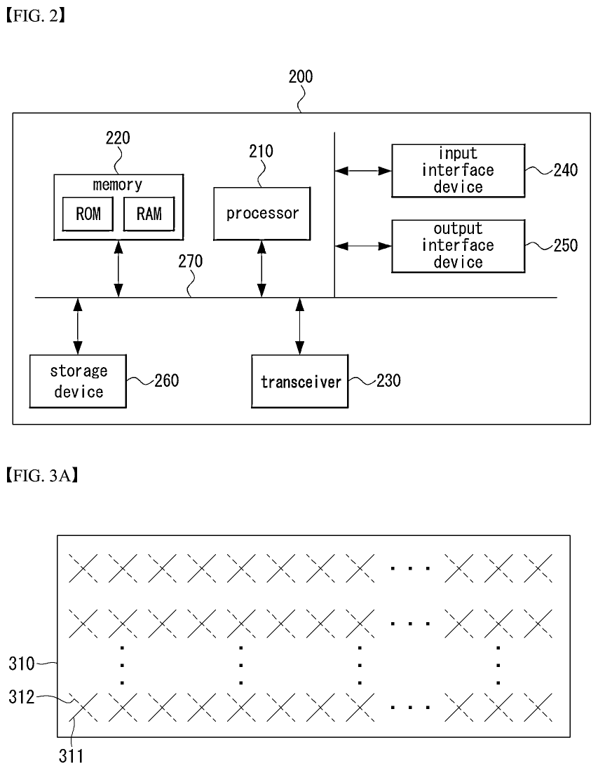

FIG. 2 is a block diagram illustrating an exemplary embodiment of a communication node constituting a communication system.

As shown in FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to operations of the plurality of base stations 110-1, 110-2, 110-3, 120-1, and 120-2, operations supported by the plurality of base stations 110-1, 110-2, 110-3, 120-1, and 120-2, or the like. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, signal transmission and reception methods in a communication system will be described. Even when a method (e.g. transmission or reception of a data packet) performed at a first communication node among communication nodes is described, the corresponding second communication node may perform a method (e.g. reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

Meanwhile, in order to process rapidly increasing wireless data, the 5G (or NR) communication or subsequent wireless communication technologies can support communication in relatively high frequency bands. For example, radio frequency bands used for wireless communication in the 5G (or NR) communication specifications may be broadly classified into frequency range 1 (FR1) bands and frequency range 2 (FR2) bands. Here, the FRI bands may refer to relatively low frequency bands as compared to the FR2 bands, which are of about 7 GHz or below. The FR2 bands may refer to relatively high frequency bands as compared to the FR1 bands, which are of about 7 GHz or above. The FR2 bands may be 28-29 GHz bands, which include unlicensed bands, millimeter wave bands, and terahertz wave bands.

In addition, in the 5G (or NR) communication system, a carrier bandwidth is defined as up to 100 MHz in FR1 and up to 400 MHz in FR2. Since the 5G (or NR) communication system requires a further increase in carrier bandwidth compared to the maximum bandwidth 20 MHz supported by the LTE system, there is a possibility that it may not be able to support the entire carrier bandwidth of up to 400 MHZ depending on a power and computing capability of a terminal. Accordingly, in the 5G (or NR) specifications, some continuous resource blocks within the carrier bandwidth are defined and used as a bandwidth part (BWP). A BWP may be defined to have a different center frequency, bandwidth, and numerology for each terminal, and one terminal can activate only one BWP within a single carrier bandwidth.

The BWP may be freely defined within the carrier bandwidth, and furthermore, the activated BWP may be switched and used as a service required by the terminal changes. Switching and using a BWP as described above may be referred to as ‘BWP adaptation’. The current 5G technical specifications describe a method of increasing scheduling flexibility by moving a center frequency, a method of increasing a bandwidth to transmit a larger amount of data, or a method of changing a numerology to select a subcarrier spacing suitable for the current service through BWP adaptation.

Describing the contents defined in the current 5G (or NR) technical specifications, one frame used when communicating within a BWP may consist of two half-frames of 5 ms each, and each half frame may consist of subframes of 1 ms each. Accordingly, there are a total of 10 subframes within one frame. Additionally, one subframe may be composed of one or multiple slots according to a subcarrier spacing (SCS). For example, one subframe may consist of one slot when an SCS of 15 KHz is used, one subframe may consist of two slots when an SCS of 30 KHz is used, and one subframe may consist of four slots when an SCS of 60 KHz is used. In this case, each slot may be composed of 14 symbols when a normal cyclic prefix (CP) is used.

As described above, the 5G (or NR) communication system uses various types of SCS, and may have different SCSs within the same bandwidth depending on the type of BWP. Since the SCS varies depending on the type of BWP, a type of reference coordinate that specifies the location of each resource block is required, which is called ‘point A’. That is, the point A may be used to designate a specific reference resource block within the corresponding BWP.

Meanwhile, the 5G (or NR) technical specifications define radio resource control (RRC) information that delivers information on a BWP to the terminal, and information on the BWP may be transmitted to the terminal through RRC signaling. Since RRC signaling is already widely known, further description thereon will be omitted.

Meanwhile, since communication is performed over a wide bandwidth in the 5G (or NR) communication system, the operation of switching an active bandwidth part (i.e. active BWP) has also been defined, and a delay that occurs in the BWP switching and a method of operating based on RRC signaling when the active BWP is switched have also been defined. That is, information required for the BWP adaptation described above, messages for transmitting at least some of the information, and procedures for transmitting the messages have been defined.

Meanwhile, the 5G (or NR) specifications define a single-panel antenna structure and a multi-panel antenna structure. However, in the 5G (or NR), only BWP adaptation for the single-panel antenna structure has been defined, and there is no defined specifications for BWP adaptation considering a case of flexibly operating each panel in the multi-panel antenna structure.

In the future, as the base station simultaneously supports more diverse scenarios including mMTC, eMBB, and URLLC, resource efficiency should be increased to serve a plurality of terminals while satisfying requirements of different terminals. Accordingly, a need to develop communication techniques considering the multi-panel antenna structure increases. The present disclosure proposes a multi-panel antenna operation technique required for BWP adaptation in the multi-panel antenna structure, and additionally describes a signaling method required in the multi-panel antenna operation process.

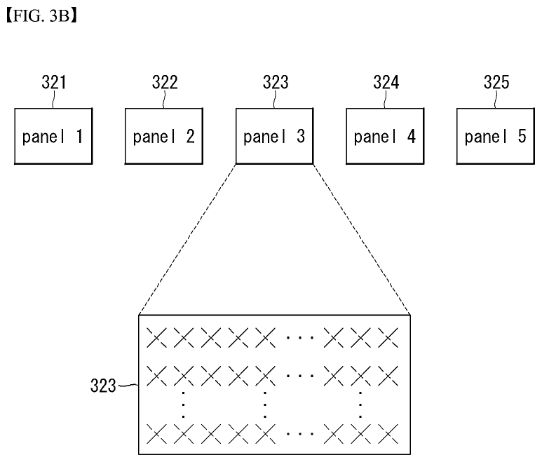

FIG. 3A is a diagram illustrating a massive antenna structure according to a single-panel antenna structure, and FIG. 3B is a diagram illustrating a structure of a plurality of panel antennas according to a multi-panel antenna structure.

As shown in FIG. 3A, a single panel antenna 310 may include a plurality of antenna elements configured in two dimensions. For example, it may be composed of M antenna elements on the horizontal axis (M is an integer equal to or greater than 2) and N antenna elements on the vertical axis (N is an integer equal to or greater than 2). One antenna element may be composed of one sub-element 311 having an inclination of 45 degrees From the horizontal axis and another sub-element 312 having an inclination of 135 degrees From the horizontal axis. That is, one antenna element may be composed of a pair of two different sub-elements. When the massive antenna is configured in a square shape, the number M of antenna elements on the horizontal axis and the number N of antenna elements on the vertical axis may have the same value.

A distance D_{H} from an intersection point between sub-elements included in each antenna element to the closest antenna on the horizontal axis may have a uniform spacing between all antenna elements, and a distance D_{V} from the intersection point between sub-elements included in each antenna element to the closest antenna on the vertical axis may have a uniform spacing between all antenna elements.

FIG. 3B illustrates a plurality of panel antennas according to a multi-antenna structure, and they may include five different panels 321, 322, 323, 324, and 325. Here, the first panel 321, second panel 322, third panel 323, fourth panel 324, and fifth panel 325 may each be one panel antenna. Hereinafter, each panel may refer to one panel antenna. In addition, although five antenna panels are shown in FIG. 3B, an actual base station may be implemented to include more panels than five panels, or may be implemented to have a plurality of panels less than five panels.

FIG. 3B illustrates an internal configuration of the third panel 323. As illustrated in FIG. 3B, one panel of the multi-panel antenna may have the same structure as the single-panel antenna previously described in FIG. 3A. However, in case of a multi-panel antenna, the number of antenna elements per panel may be smaller than the number of antenna elements included in a single-panel antenna. For example, when a single-panel antenna is implemented with 100 antenna elements, in case of a multi-panel antenna having four panel antennas, each panel antenna may be configured to include 25 antenna elements. In case of a multi-panel antenna structure in the 5G (or NR) specifications, each panel antenna is defined to have the same number of antenna elements. In this multi-panel antenna structure, since the number of antenna elements provided in each panel is smaller than the number of antenna elements included in a single-panel antenna structure, communication is possible with relatively low computational complexity and low power consumption.

As illustrated in FIG. 3B, in a communication system using a multi-panel antenna, a base station or communication device may transmit and receive signals through radio interface(s) with at least one terminal or another communication device through the respective panel antennas. In addition, it is possible to allocate BWPs including the same frequency to different panels. Describing this by taking an example of a case where communication is performed between the base station and terminals, the base station may allocate a BWP1 including a first frequency f1 to the first panel 321 and communicate with a first terminal through the BWP1. In this case, the base station may allocate a BWP2 including the first frequency f1 to the third panel 323 and communicate with a second terminal through the BWP2. In this case, the BWP1 and BWP2 may have the same frequency band or different frequency bands.

Allowing the multi-panel antenna as shown in FIG. 3B is already defined in the 5G (or NR) specifications. In addition, the current 5G (or NR) specifications include a codebook design considering the multi-panel antenna structure. However, in the 5G (or NR), only BWP adaptation for the single-panel antenna structure has been defined, and there is no defined specifications for BWP adaptation considering a case of flexibly operating each panel in the multi-panel antenna structure.

In the future, as the base station simultaneously supports more diverse scenarios including the mMTC, eMBB, and URLLC, resource efficiency should be increased to serve a plurality of terminals while satisfying requirements of the different terminals. Accordingly, a need to develop communication techniques considering the multi-panel antenna structure increases. In addition, in the process of flexibly allocating a BWP, the performance of panels should be identified according to specific criteria and a panel should be selected according to a given situation. In addition, it is necessary to define a signaling method for transmitting and receiving information required for selection of panel(s) and notification of the selected panel(s).

The present disclosure described below provides a technique for flexibly allocating a BWP in a multi-panel antenna structure according to a situation, that is, a technique for operating a multi-panel antenna during BWP adaptation.

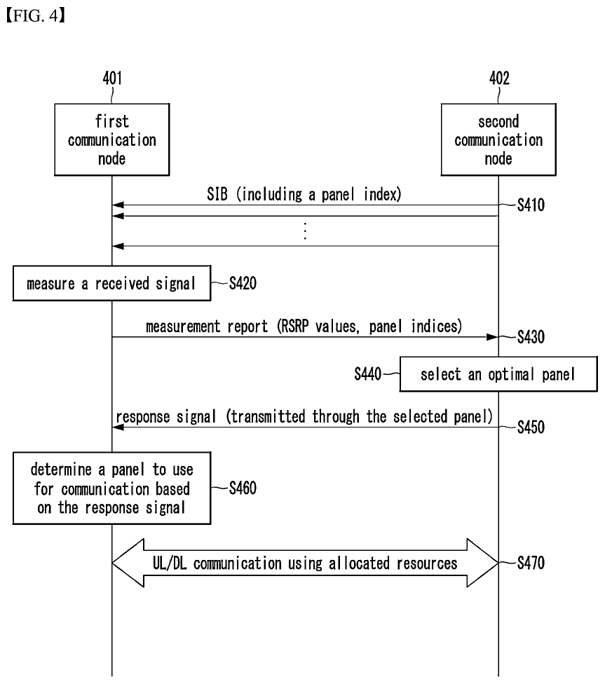

FIG. 4 is a signal flow diagram describing selection for a multi-panel antenna based on signal measurements between communication devices according to the present disclosure.

As shown in FIG. 4, each of a first communication device 401 and a second communication device 402 may be one of the communication devices 110-1, 110-2, 110-3, 120-1, 120-2, 130-1, 130-2, 103-3, 130-4, 130-5, and 200 previously described in FIGS. 1 and 2. The signal flow illustrated in FIG. 4 may be applied to the NR communication system, an example of 5G communication currently under development, with some services being provided. In addition, it may also be applied to 6G communication, which is expected to use a higher frequency band than the 5G communication in the future. The first communication device 401 and the second communication device 402 described below may both be specific terminals and/or user equipment (UEs). A case where the first communication device 401 and the second communication device 402 are both terminals (or UEs) may correspond to a form of communication without a base station, such as direct communication between devices (D2D), IoT, and/or V2X. The present disclosure may also be applied to such communication schemes between terminals. However, a case where the second communication device 402 is a terminal may correspond to a form of having a multi-panel antenna as previously illustrated in FIG. 3B.

As another example, the first communication device 401 may be a terminal, and the second communication device 402 may be a specific access point (AP). The case where the second communication device 402 is implemented as an AP may also correspond to the form of having a multi-panel antenna as previously illustrated in FIG. 3B.

However, for convenience of description, in the following description, it is assumed that the first communication device 401 is a UE, and the second communication device 402 is a base station. In particular, in the following description, for convenience of description, it is assumed that the second communication device 402 is a gNB, which is a base station according to the NR communication specifications among various base station equipment. Accordingly, in the following description, a gNB may be understood as the second communication device 402. However, the present disclosure is not limited to the NR communication scheme and may also be applied to 6G communication, which is expected to use a high frequency band such as NR or a higher frequency band. In addition, the present disclosure may be applied to any wireless communication system that can adopt methods described below.

According to an exemplary embodiment of the present disclosure, the second communication device 402 may transmit a system information block (SIB) at a predetermined periodicity in step S410. FIG. 4 illustrates an example in which an SIB is transmitted through each panel. In other words, since each SIB is transmitted for each panel, the SIBs may be transmitted at the same time or at different times, and this is exemplified as reference numeral S410 in FIG. 4.

The SIB according to the present disclosure may include a panel index or panel identifier to identify each panel. The panel index and panel identifier may be used with the same meaning, and in the present disclosure, any form that can identify a panel may be sufficiently utilized. Therefore, the following description will assume a case of using a panel index.

As previously illustrated in FIG. 3B, when there are five panels, panel identifiers may be exemplified as shown in Table 1 below.

TABLE 1

| panel | panel index (3 bits) |
|---|---|
| panel #1 | 0 (000) |
| panel #2 | 1 (001) |
| panel #3 | 2 (010) |
| panel #4 | 3 (011) |
| panel #5 | 4 (100) |

As exemplified in Table 1, when five panels are implemented, different panels may be identified with only a 3-bit index. For example, the first panel 321 may be mapped to a panel index ‘000’, the second panel 322 may be mapped to a panel index ‘001’, the third panel 323 may be mapped to a panel index ‘010’, the fourth panel 324 may be mapped to a panel index ‘011’, and the fifth panel 325 may be mapped to a panel index ‘100’. Through this, the first communication device 401 may identify from which panel the SIB is received. In the present disclosure, five panels are described as an example, but this is merely one example, and the present disclosure may be applied also when two or more panels are used.

Here, when determining a panel index, the second communication device 402 may determine an index value using a ceiling function corresponding to the number of panels. For example, if the number of panels included in the second communication device 402 is n, the number of bits of the panel index may be determined as shown in Equation 1 below.

$$The number of bits for index = ceil ( {log}_{2} n ) bits \qquad [ Equation 1 ]$$

In step S410, the second communication device 402 may transmit an SIB by including each panel index in the SIB. For example, the second communication device 402 may transmit an SIB including the panel index ‘000’ through the first panel 321, transmit an SIB including the panel index ‘001’ through the second panel 322, transmit an SIB including the panel index ‘010’ through the third panel 323, transmit an SIB including the panel index ‘011’ through the fourth panel 324, and transmit an SIB including the panel index ‘100’ through the fifth panel 325.

Meanwhile, a case where the first communication device 401 acquires initial synchronization and system information of the second communication device 402 based on a signal received through a specific panel. In other words, even when the second communication device 402 provides synchronization signals and system information through a plurality of panels, the first communication device 401 may acquire synchronization and system information based only on a signal received through one panel, for example, the first panel 321. In this case, step S410 may be performed using an RRC message rather than an initial synchronization acquisition procedure. For example, the second communication device 402 may use an RRC reconfiguration message instead of the SIB through the first panel 321 to indicate presence of other panels and indicate to measure communication signals received through the other panels used for communication by the second communication device 402 as well as the current panel. In this case, the measurement indication may use UEInformationRequest of the RRC reconfiguration message.

For convenience of description, in the following description, it will be assumed that the first communication device 401 receives SIBs through all panels of the second communication device 402.

In step S410, the first communication device 401 may receive SIBs transmitted from the second communication device 402 through a plurality of panels. Since the SIBs include the respective panel indices as described above, the first communication device 401 may identify a panel through which a specific SIB is received by using the corresponding panel index.

In step S420, the first communication device 401 may receive the signals transmitted by the second communication device 402, and measure a strength of each of the received signals. For example, in step S420, the first communication device 401 may receive a PBCH for each panel, which is periodically transmitted by the second communication device 402, and measure a received signal strength of the PBCH for each panel. In the present disclosure, a received signal received power (RSRP) may refer to a signal strength of the entire received signal.

In step S430, the first communication device 401 may report the strength of the received signal measured in step S420 to the second communication device 402 using an RSRP value, an index corresponding to the RSRP value, or both. When the first communication device 401 reports the RSRP value and the index corresponding to the RSRP value for each panel, the reporting may be done using messages shown in Table 2 below.

TABLE 2

| panel | panel index (3 bits) | RSRP index | RSRP reported value |
|---|---|---|---|
| panel #1 | 0 (000) | RSRP_#1 | RSRP_111 |
| panel #2 | 1 (001) | RSRP_#2 | RSRP_97 |
| panel #3 | 2 (010) | RSRP_#3 | RSRP_78 |
| panel #4 | 3 (011) | RSRP_#4 | RSRP_56 |
| panel #5 | 4 (100) | RSRP_#5 | RSRP_24 |

The panel indices in Table 2 may be the panel indices based on Table 1 described above. In addition, the RSRP reported value may be a value for the first communication device 401 to receive a specific channel (e.g. PBCH) and report in response to a received signal power of the received PBCH. In general, the RSRP reported value may indicate a power range selected based on an actually measured value. In addition, the RSRP index may be an index to indicate one RSRP reported value. Accordingly, the RSRP index and RSRP reported value may indicate the same power range.

According to an exemplary embodiment of the present disclosure, the reporting according to Table 2 may be made only through a specific panel selected by the first communication device 401. For example, the first communication device 401 may transmit a message including information as shown in Table 2 through one specific panel. The panel selected by the first communication device 401 may be a panel with the largest RSRP value or a panel through which the first communication device 401 is communicating with the second communication device 402.

According to another exemplary embodiment of the present disclosure, a measurement report from the first communication device 401 to the second communication device 402 may deliver only an RSRP index and an RSRP reported value for each panel through the corresponding panel. When the first communication device 401 reports for each panel, the panel index may not be included. When the first communication device 401 transmits information on the RSRP for each panel as described above, the second communication device 402 may collect information on the RSRPs received for the respective panels from the first communication device 401, and store the collected information in a memory for a predetermined time by mapping them in the form shown in Table 2.

According to yet another exemplary embodiment of the present disclosure, the first communication device 401 may transmit all measurement report information in Table 2 to the second communication device 402 through the respective panels. For example, the first communication device 401 may transmit a message including information as shown in Table 2 through the first panel 321, second panel 322, third panel 323, fourth panel 324, and fifth panel 325.

In step S430, the second communication device 402 may receive the measurement report transmitted by the first communication device 401. The measurement report may be transmitted using at least one of the methods described above.

In step S440, the second communication device 402 may select an optimal panel based on the received measurement report(s). For example, it may be assumed that the reporting is made as shown in Table 2. In addition, in Table 2, a higher RSRP reported value may indicate a better channel state. For example, RSRP_111 may be a higher RSRP than RSRP_97, and RSRP_111 may indicate a better channel state than RSRP_97. Based on the RSRP reported values in Table 2, the channel states for the panels may be organized in descending order as follows.

$$Panel 1 > Panel 2 > Panel 3 > Panel 4 > Panel 5$$

That is, from the perspective of the first communication device 401, the first panel 321 has the highest RSRP value for the signal transmitted by the second communication device 402, and thus it may be considered to have the best channel state. In addition, from the perspective of the first communication device 401, the fifth panel 325 has the lowest RSRP value for the signal transmitted by the second communication device 402, and thus it may be considered to have the worst channel state.

In step S440, the second communication device 402 may select a panel with the highest RSRP value, that is, a panel having the best channel, as an optimal panel based on the measurement information received for the first communication device 401.

In step S450, the second communication device 402 may transmit a response signal to the first communication device 401. In this case, one of methods below may be used to transmit the response signal.

According to an exemplary embodiment of the present disclosure, the response signal including panel information indicating the optimal panel may be transmitted to the first communication device 401 through all panels. According to another exemplary embodiment of the present disclosure, the response signal including the panel information indicating the optimal panel may be transmitted to the first communication device 401 through only the selected panel. According to yet another exemplary embodiment of the present disclosure, the response signal including the panel information indicating the optimal panel may be transmitted to the first communication device 401 through at least one panel among the selected panel and an arbitrary panel. According to yet another exemplary embodiment of the present disclosure, the response signal including the panel information indicating the optimal panel may be transmitted to the first communication device 401 through at least one arbitrary panel.

The response signal transmitted from the second communication device 402 to the first communication device 401 in step S450 may use at least one among an RRC message, an RRC reconfiguration message, a response message in response to receipt of the measurement report, or a newly defined message for indicating the optimal panel. The messages exemplified in the present disclosure are merely examples to aid understanding, and are not limited thereto. Therefore, according to an exemplary embodiment of the present disclosure, any message (or signal) for another purpose may be used as long as it can be transmitted by directly or implicitly including the information indicating the optimal panel.

In step S450, the first communication device 401 may receive the response signal transmitted by the second communication device 402. After receiving the response signal, the first communication device 401 may determine a panel to use for communication based on the received response signal in step S460.

In step S470, the second communication device 402 may allocate resources to the first communication device 401, and the first communication device 401 may use the resources allocated by the second communication device 402 to perform uplink and/or downlink communication. In this case, the first communication device 401 may communicate with the second communication device 402 using the panel determined in step S460. In addition, the second communication device 402 may communicate with the first communication device 401 through the panel selected in step S440.

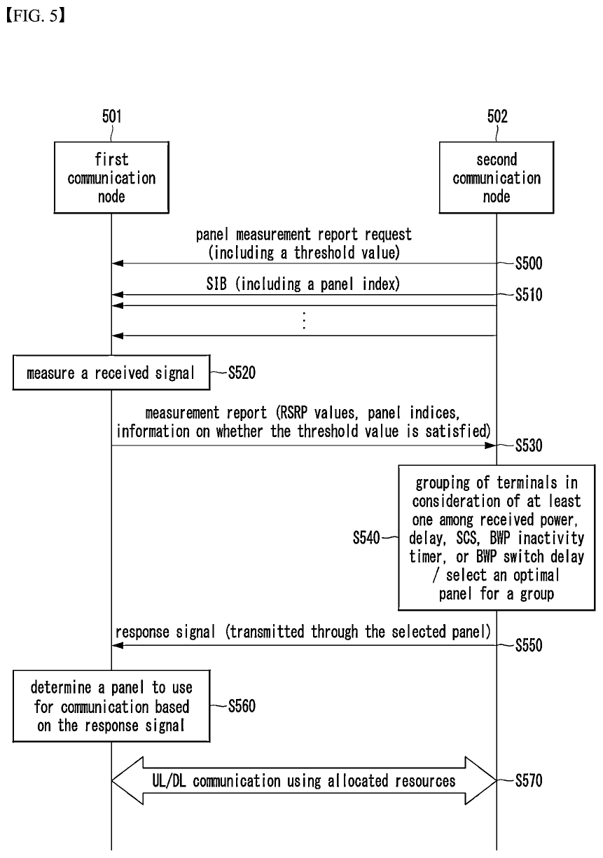

FIG. 5 is a signal flow diagram describing panel selection and communication during BWP adaptation according to another exemplary embodiment of the present disclosure.

As shown in FIG. 5, each of a first communication device 501 and a second communication device 502 may be one of the communication devices 110-1, 110-2, 110-3, 120-1, 120-2, 130-1, 130-2, 103-3, 130-4, 130-5, and 200 previously described in FIGS. 1 and 2. The signal flow illustrated in FIG. 5 may be applied to the NR communication system, an example of 5G communication currently under development, with some services being provided. In addition, it may also be applied to 6G communication, which is expected to use a higher frequency band than the 5G communication in the future. The first communication device 501 and the second communication device 502 described below may both be specific terminals and/or user equipment (UEs). A case where the first communication device 501 and the second communication device 502 are both terminals (or UEs) may correspond to a form of communication without a base station, such as direct communication between devices (D2D), IoT, and/or V2X. The present disclosure may also be applied to such communication schemes between terminals. However, a case where the second communication device 502 is a terminal may correspond to a form of having a multi-panel antenna as previously illustrated in FIG. 3B.

As another example, the first communication device 501 may be a terminal, and the second communication device 502 may be a specific access point (AP). The case where the second communication device 502 is implemented as an AP may also correspond to the form of having a multi-panel antenna as previously illustrated in FIG. 3B.

However, for convenience of description, in the following description, it is assumed that the first communication device 501 is a UE, and the second communication device 502 is a base station. In particular, in the following description, for convenience of description, it is assumed that the second communication device 502 is a gNB, which is a base station according to the NR communication specifications among various base station equipment. Accordingly, in the following description, a gNB may be understood as the second communication device 502.

The flowchart of FIG. 5 may be an example of an operation in which the second communication device 502 deactivates a currently activated BWP and activates a new BWP for communication with the first communication device 501 during BWP adaptation. As described above, during the BWP adaption, a procedure in which the second communication device 502 activates a BWP other than the currently activated BWP to communicate with the first communication device 501, or a procedure in which the second communication device 502 switches the currently activated BWP to one of other deactivated BWPs may be performed.

When switching a BWP, a new BWP may be defined by changing a frequency reference point (carrier offset), frequency bandwidth, and numerology, and the newly-defined BWP may be activated. As another example, it is also possible to activate one of the previously defined, but currently deactivated BWPs.

Since it is necessary to decide which panel to select when switching the BWP in the multi-panel antenna structure, the present disclosure will describe methods for making this decision.

According to an exemplary embodiment of the present disclosure, the second communication device 502 may transmit a panel measurement report request message to the first communication device 501 in step S500. Although only one first communication device 501 is illustrated in FIG. 5, when the second communication device 502 is a base station, measurement report request message(s) may be transmitted to multiple UEs or all UEs included within the base station. The base station may transmit the measurement report request message(s) to a plurality of UEs and/or all UEs at the same time or at different times for the respective UEs, depending on the type of message(s).

According to an exemplary embodiment of the present disclosure, the panel measurement report request message may be information commonly broadcast by the base station to all UEs. When the panel measurement report request message is broadcast, all UEs may receive the panel measurement report request message at the same time. In addition, a timing at which each of all UEs performs measurement reporting may vary based on the panel measurement report request message broadcast by the base station and/or specific information configured exclusively for each UE by the base station.

According to another exemplary embodiment of the present disclosure, the base station may transmit the panel measurement report request message dedicatedly to each specific UE. For example, the report may be requested from each UE using an RRC message or an RRC reconfiguration message. For example, information on a panel index and information related to RSRP measurement and reporting of a specific signal may be transmitted to the UE using UEInformationRequest in the RRC reconfiguration message. In addition, when delivering a threshold value, the threshold value may be delivered through MeasConfig in the RRC reconfiguration message.

The panel measurement report request message transmitted from the second communication device 502 to the first communication device 501 in step S500 may include the threshold value according to the present disclosure. Here, the threshold value may be the minimum RSRP value for the second communication device 502 to communicate with the first communication device 501.

In step S500, the first communication device 501 may receive the panel measurement report request message and perform measurements on a plurality of panels at time(s) specified in the panel measurement report request message. That is, in step S510, the first communication device 501 may receive an SSB transmitted by the second communication device 502 for each panel, and measure a received signal strength of the SSB received for each panel in step S520. In the present disclosure, the SSB received for each panel is described as an example, but if a signal other than the SSB can be measured, a received signal strength of the measurable signal may also be measured.

Assuming that there are five panels as described in FIG. 4, SSBs may be transmitted for the respective five panels in step S510. In this case, each SSB may include a panel index. The panel index may have the form in Table 1 and Equation 1 described above.

In step S520, the first communication device 501 may measure a signal strength of the SSB transmitted for each panel in step S510 based on the panel measurement report request message received in step S500. In addition, if a threshold value is included in step S500, in step S520, the first communication device 501 may determine whether the signal strength is suitable or not suitable for communication with the second communication device 502 based on comparison with the threshold value. For example, it is possible to identify whether the measured received signal strength of the SSB received through the first panel 321 satisfies the threshold value or greater by comparing it with the threshold value received in step S500.

In step S530, the first communication device 501 may transmit a measurement report to the second communication device 502. The information transmitted in step S530 may include, for example, information as shown in Table 3 below.

TABLE 3

| | | RSRP reported | Whether a threshold value is |
|---|---|---|---|
| panel | RSRP index | value | satisfied (RSRP ≥ RSRP_{TH}) |
| panel #1 | RSRP #1 | RSRP_111 | Satisfied (or suitable) |
| panel #2 | RSRP #2 | RSRP_97 | Satisfied (or suitable) |
| panel #3 | RSRP #3 | RSRP_78 | Satisfied (or suitable) |
| panel #4 | RSRP #4 | RSRP_56 | Dissatisfied (or unsuitable) |
| panel #5 | RSRP_#5 | RSRP_24 | Dissatisfied (or unsuitable) |

In Table 3, information on whether the threshold value is satisfied or not is either ‘satisfied’ or ‘dissatisfied’, and thus the information may be indicated with 1 bit. In addition, the information shown in Table 3 is provided as an example, and all values may not need to be included. According to an exemplary embodiment of the present disclosure, the measurement report may include only a panel index for identifying each panel and an RSRP reported value corresponding to each panel. According to another exemplary embodiment of the present disclosure, the measurement report may only include a panel index for identifying each panel, an RSRP reported value corresponding to each panel, and whether the threshold value is satisfied. According to yet another exemplary embodiment of the present disclosure, the measurement report should include a panel index for identifying each panel, and may include one or more of an RSRP index corresponding to each panel, an RSRP reported value, or whether the threshold value is satisfied.

When the first communication device 501 does not provide information on whether the threshold value is satisfied, the second communication device 502 may additionally identify whether the threshold value is satisfied based on the RSRP reported value and the threshold value. In addition, when the first communication device 501 does not provide information on whether the threshold value is satisfied, the threshold value may not be included in the panel measurement report request message in step S500.

As a method by which the first communication device 501 transmits the measurement report in step S530, the same method as the method of transmitting the measurement report in step S430 of FIG. 4 may be used. However, since the example of FIG. 4 corresponds to an initial access state, there is a limit to the types of messages that the first communication device 401 can transmit. However, since the example of FIG. 5 is a procedure for BWP adaptation, one of more types of messages in the 5G (or NR) system may be used. For example, the information on the panel index may be transmitted using UEInformationResponse. As another example, the information on the panel index may be transmitted using Measurement Report of the RRC reconfiguration message. As another example, the information on the panel index may be transmitted using UE Assistance Information.

In step S540, two cases may be considered for the second communication device 502.

The first case may correspond to a case where the second communication device 502 considers only one communication device when selecting a panel, and the second case may correspond to a case where the second communication device 502 considers a plurality of communication devices when selecting a panel.

First, the case where only one communication device is considered will be described.

In step S540, the second communication device 502 may select an optimal panel based on the received power measurement reports received from the first communication device 501. Based on the example in Table 3, the second communication device 502 may identify that the panel 321, the second panel 322, and the third panel 323 can be used to communicate with the first communication device 501, and may identify that the fourth panel 324 and the fifth panel 325 cannot be used to communication with the first communication device 501. Accordingly, the second communication device 502 may select the optimal panel among the first panel 321, the second panel 322, and the third panel 323.

When only the first communication device 501 and the second communication device 502 are considered in step S540, the first panel 321 may be the most optimal panel according to Table 3. Therefore, when only the first communication device 501 and the second communication device 502 are considered, the second communication device 502 may select the first panel 321 as the optimal panel for the first communication device 501.

Accordingly, the second communication device 502 may transmit a response signal to the first communication device 501 in step S550. The transmission operation of the response signal may be the same as step S450 described in FIG. 4. According to an exemplary embodiment of the present disclosure, the response signal including panel information indicating the optimal panel may be transmitted to the first communication device 501 through all panels. According to another exemplary embodiment of the present disclosure, the response signal including the panel information indicating the optimal panel may be transmitted to the first communication device 501 through only the selected panel. According to yet another exemplary embodiment of the present disclosure, the response signal including the panel information indicating the optimal panel may be transmitted to the first communication device 501 through at least one panel among the selected panel and an arbitrary panel. According to yet another exemplary embodiment of the present disclosure, the response signal including the panel information indicating the optimal panel may be transmitted to the first communication device 501 through at least one arbitrary panel.

In addition, since the example of FIG. 5 corresponds to a state where communication is being performed between the first communication device 501 and the second communication device 502 through a specific panel, the response signal may be transmitted through the specific panel and a BWP with which the communication is currently being performed. In addition, the response signal may be transmitted through a newly selected panel as well as the panel with which the communication is currently being performed.

Then, the case of selecting a panel considering multiple communication devices will be described. A representative example in which the second communication device 502 communicates with a plurality of communication devices may be a case where the second communication device 502 is a base station and the first communication device 501 is a UE within the base station. As another example, when both the first communication device 501 and the second communication device 502 are UEs, a case where the second communication device 502 communicates with a plurality of other communication devices in the inter-device communication scheme such as sidelink may be considered. For convenience of description, the following description assumes that the first communication device 501 is a terminal and the second communication device 502 is a base station.

### (1) Panel Allocation Considering an SCS of a BWP

The second communication device 502, which is a base station, needs to consider a plurality of terminals. In addition, when the base station wishes to activate a specific BWP for allocation to a terminal, the base station may allocate a panel by considering an SCS of the BWP.

Specifically, as shown in Table 3, the first communication device 501 may communicate using the first panel 321, the second panel 322, and the third panel 323. In addition, the second communication device 502 may receive information as shown in Table 3 from other communication devices in addition to the first communication device 501. Based on the information as shown in Table 3 received from a plurality of UEs, the base station may determine a group of terminals capable of communicating with the same panel, i.e. a group of terminal having at least one common panel among the panels (i.e. the first, second, and third panels) through which the base station can communicate with the first communication device 501.

For example, it may be assumed that a terminal A, terminal B, terminal C, terminal D, terminal E, terminal F, and terminal G are all communication devices that can use the same panel. Additionally, it may be assumed that the first communication device 501 is the terminal A in the above example.

In this case, the terminals A to terminal G may each be allocated to a panel with the best received power when only one terminal is considered. However, in the present disclosure, other factors may be considered in addition to the best received power. This is to utilize panel resources more efficiently in the system using the multi-panel antenna.

According to an exemplary embodiment of the present disclosure, when selecting a panel, the panel may be selected by considering SCSs for a group of specific terminals (e.g. terminal A to terminal G). For example, it may be preferable to allocate terminals with the same SCS from the above-described group of terminals to one panel.

In general, a case where the base station allocates a terminal with a large SCS and a terminal with a small SCS to the same panel will be described. As described earlier, according to the NR specifications, SCSs of 15 KHz, 30 KHz, 60 KHz, 120 KHz, and 240 KHz may be used. As an SCS increases, a bandwidth of a BWP to be activated increases, and thus a puncturing effect may occur in which the terminal with a small SCS is temporarily unable to communicate due to the terminal with a large SCS.

Further describing the puncturing effect, when a BWP including a specific frequency is activated for one panel, another BWP including the specific frequency cannot be activated for the same panel. When terminals with wide bandwidths are distributed and allocated to multiple panels, a probability that another terminal is temporarily unable to communicate with the base station at a specific moment due to the terminals may increase. Conversely, when terminals with small bandwidths are distributed and allocated to multiple panels, a phenomenon occurs in which terminals with relatively large bandwidths cannot be allocated panels due to the terminals with the small bandwidths. This phenomenon is called the puncturing effect.

In addition, when BWPs with different numerologies are activated for the same panel, orthogonality of subcarriers is not guaranteed, and thus an inter-numerology interference (INI) problem in which a BWP with a large SCS interferes with a BWP with a small SCS may occur.

Therefore, the greater a difference in SCSs of two terminals, the greater the influence of INI. Considering the puncturing effect and INI, it may be preferable to allocate terminals with the same SCS to the same panel as much as possible.

In order to reduce the puncturing effect and INI as described above, it may be preferable for the second communication device 502, which is a base station, to allocate terminals with the same SCS to one panel.

Table 4 is an example of panel allocation to terminals grouped with the first communication device 501 according to the present disclosure.

TABLE 4

| terminal | SCS | Panel | Panel index (3 bits) |
|---|---|---|---|
| terminal A | SCS #1 | panel 1 | 0 (000) |
| terminal B | SCS #1 | panel 1 | 0 (000) |
| terminal C | SCS #2 | panel 2 | 1 (001) |
| terminal D | SCS #2 | panel 2 | 1 (001) |
| terminal E | SCS #3 | panel 3 | 2 (010) |
| terminal F | SCS #3 | panel 3 | 2 (010) |
| terminal G | SCS #4 | | |

As exemplified in Table 4, seven terminals, including the terminal A, terminal B, terminal C, terminal D, terminal E, terminal F, and terminal G, may be terminals belonging to one group. Here, the group to which the seven terminals belong may be a group of terminals for which the first to third panels satisfy the threshold value or greater, as described in Table 3. In addition, it is assumed that the terminal A and terminal B require an SCS #1, the terminal C and terminal C require an SCS #2, the terminal E and terminal F require an SCS #3, and the terminal G requires an SCS #4. Here, the SCS required by each terminal may mean an SCS of a BWP that each terminal wishes to activate. As described above, each of SCS #1 to SCS #4 may correspond to one of 15 KHz, 30 KHz, 60 KHz, 120 KHz, and 240 KHz, and a range of SCSs that can be selected may be limited depending on the type of FR (i.e. FR1 or FR2). It is assumed that the above-described SCS #1 to SCS #4 are all for the same type of FR.

According to the example in Table 4, the second communication device 502, which is a base station, may allocate the first panel 1 321 to the terminal A and terminal B, allocate the second panel 322 to the terminal C and terminal D, and allocate the third panel 323 to the terminal E and terminal F. However, since the terminal G does not require the same SCS as other terminals in the group, it may be excluded from allocation for the group and additional allocation may be considered therefor. The additional allocation may be to allocate a panel based on communication of a single terminal as described above.

In addition, when allocating a panel, the panel may selected using one of methods below. A process by which the second communication device 502, which is a base station, allocates a panel to the terminal A and terminal B will be described.

As exemplified in Table 4, since both the terminal A and terminal B require the SCS #1, the same panel may be selected for the terminal A and terminal B. In addition, one of the first panel 321 to the third panel 323 may be selected.

Therefore, the base station may need to decide which SCS among the plurality of SCSs to allocate to which panel. Therefore, an example of a method for deciding which SCS to allocate to which panel will be described. First, it may be assumed that the group of terminals A to terminal G may be divided into a first subgroup of the terminal A and terminal B, a second subgroup of the terminal C and terminal D, and a third subgroup of the terminal E and terminal F.

According to an exemplary embodiment of the present disclosure, the base station may select an arbitrary subgroup and allocate a panel to terminals of the selected subgroup.

According to another exemplary embodiment of the present disclosure, the base station may allocate panels starting from a subgroup with a large SCS value or from a subgroup with a small SCS value.

According to yet another exemplary embodiment, the base station may first select a panel based on the number of terminals included in a subgroup. For example, when the number of terminals included in a subgroup requiring the SCS #1 is 10, the number of terminals included in a subgroup requiring the SCS #2 is 4, and the number of terminals included in a subgroup requiring the SCS #3 is 18, the base station may first select a panel for the subgroup requiring the SCS #3, then select a panel for the subgroup requiring the SCS #1, and then allocate the remaining panel to the subgroup requiring the SCS #2.

According to yet another embodiment, the base station may determine a panel selection order based on a cumulative value or an average value of reported RSRP values of terminals requiring a specific SCS. For example, when selecting a panel, the base station may first allocate a panel to the subgroup of the terminals A and B if an average of RSRP values reported by the terminal A and terminal B is greater than RSRP values reported by terminals required other SCSs.

According to yet another embodiment of the present disclosure, the base station may select a panel based on a high priority terminal or the number of high priority terminals among the terminals A to terminal G. For example, when the terminal C, terminal D, and terminal F have the highest priority, since the subgroup of the terminal C and terminal D requiring the SCS #2 has a largest number of high priority terminals, a panel for the subgroup for the terminals C and D may be selected first. Then, a panel for the subgroup of the terminals E and F, including the terminal F, may be selected, and finally the remaining panel may be allocated to the terminals A and B.

The method described above may be a method that considers how to prevent a communication failure and INI due to the puncturing effect by allocating the same panel to terminals with the same SCS as much as possible when selecting the panel considering the SCSs. In addition, the present disclosure described an order in which panels are allocated to the SCSs required by terminals for which the same panel is evaluated as satisfactory for communication.

### (2) Panel Selection Considering BWP Inactivity Timer

When allocating a panel to terminal(s) in the multi-panel antenna system, the panel may be allocated taking into account BWP inactivity timer value(s).

In general, the larger the BWP inactivity timer value, the longer it takes for the terminal to switch from a currently activated and used BWP to a default BWP. This means that a time occupied by the currently activated and used BWP increases, and may act as a limitation in activating a new BWP that uses at least some frequencies of the currently activated and used BWP. In other words, when wishing to activate a new BWP, if deactivation of a BWP with a large BWP inactivity timer value is required, a time required for activating the new BWP may increase.

In addition, when multiple BWPs with different BWP Inactivity timer values are allocated to one panel, there is a delay in activating a new BWP for the panel, which reduces the efficiency of BWP utilization for the panel.

Therefore, in order to avoid deteriorating the communication performance of several other terminals due to one terminal, the present disclosure proposes a method of allocating terminals with similar BWP inactivity timer values to the same panel.

Table 5 is an example in which the second communication device 501 allocates panels according to BWP inactivity timer values when allocating panels to terminals according to the present disclosure.

TABLE 5

| | BWP inactivity timer | BWP inactivity timer | Panel index |
|---|---|---|---|
| terminal | value | index | (3 bits) |
| terminal A | bwpInactivityTimer A | bwpInactivityTimer #1 | panel 1 (000) |
| terminal B | bwpInactivityTimer B | bwpInactivityTimer #1 | panel 1 (000) |
| terminal C | bwpInactivityTimer C | bwpInactivityTimer #2 | panel 2 (001) |
| terminal D | bwpInactivityTimer D | bwpInactivityTimer #2 | panel 2 (001) |
| terminal E | bwpInactivityTimer E | bwpInactivityTimer #3 | panel 3 (010) |
| terminal F | bwpInactivityTimer F | bwpInactivityTimer #3 | panel 3 (010) |
| terminal G | bwpInactivityTimer G | | |

In Table 5, the BWP inactivity timer value is a value set in response to an activated BWP. As in Table 4, seven terminals, including the terminal A, terminal B, terminal C, terminal D, terminal E, terminal F, and terminal G, may be terminals belonging to one group. Here, the group to which the seven terminals belong may be a group of terminals for which the first to third panels satisfy the threshold value or greater, as described in Table 3.

Table 5 shows that each terminal has a BWP inactivity timer value for a BWP it wishes to activate, and each value may be a different value. As exemplified in Table 5, the terminal A has a value of bwpInactivityTimer A, the terminal B has a value of bwpInactivityTimer B, the terminal C has a value of bwpInactivityTimer C, the terminal D has a value of bwpInactivityTimer D, the terminal E has a value of bwpInactivityTimer E, the terminal F has a value of bwpInactivityTimer F, and the terminal G has a value of bwpInactivityTimer G.

The BWP inactivity timer values may be divided into several time sections. In the example in Table 5, it is assumed that they are divided into three time sections. It is assumed that bwpInactivityTimer #1 is an index for the first time section, bwpInactivityTimer #2 is an index for the second time section, and bwpInactivityTimer #3 is an index for the final third time section. When divided into three time sections as described above, each index may be determined as 2 bits according to the method of Equation 1 described above.

In the present disclosure, the panels may be allocated to the terminals A to terminal G based on the indices divided into three sections. According to the example in Table 5, the base station may allocate the first panel to the terminal A and terminal B because both the terminal A and terminal the B have the index bwpInactivityTimer #1. In addition, the base station may allocate the second panel to the terminal C and terminal D because both the terminal C and terminal D have the index bwpInactivityTimer #2. Further, the base station may allocate the third panel to the terminal E and terminal F because both the terminal E and terminal F have the index bwpInactivityTimer #3.

Finally, the terminal G may not be able to operate because there is no panel or BWP suitable for the BWP inactivity timer of the terminal G during the panel selection process. Therefore, the terminal G may be excluded from panel allocation considering the BWP inactivity timer. For the terminal G, a panel may be selected based on other schemes, for example, the above-described schemes based on RSRP measurement report and/or SCS.

Meanwhile, similarly to the method using SCSs described previously using Table 4, even when using the BWP inactivity timers, it may be necessary to determine for which subgroup to preferentially select a panel among the first subgroup of terminal A and terminal B, the second subgroup of terminals C and D, and the third subgroup of terminals E and F from the group of terminals A to G. Since the methods described above may be used to determine for which of the subgroups to preferentially allocate a panel, similar description thereon will be omitted.

### (3) Panel Allocation Considering a BWP Switch Delay of a BWP to be Activated During BWP Adaptation

The second communication device 502, which is a base station, needs to consider a plurality of terminals, and when the base station wishes to activate a specific BWP to allocate the BWP to a terminal, the base station may allocate a panel by considering a BWP switch delay of the BWP.

A BWP switch delay may be longer as an SCS of a BWP with a smaller SCS among BWPs before and after BWP switching is smaller, and the BWP switch delay may become additionally longer when BWP switching between different SCSs is required. The longer the BWP switch delay, the more time it takes for a currently activated and used BWP to be switched to a newly allocated BWP. Therefore, a time during which a band occupied by the corresponding BWP cannot be used may increase.

Therefore, when BWPs with different BWP switch delays are allocated to one panel, a new BWP may not be allocated quickly due to a BWP with a relatively long BWP switch delay, which may cause a delay. The present disclosure provides a panel allocation method to prevent communication performance of several other terminals from being degraded due to one terminal.

The BWP switch delay may refer to a delay time that occurs during BWP switching, and the terminal may not be able to transmit an uplink (UL) signal or receive a downlink (DL) signal during a time corresponding to the BWP switch delay. In the present disclosure, the BWP switch delay of the terminal may be referred to as T_BWPswitchdelay.

Table 6 is an example in which the second communication device 501 allocates panels according to the BWP switch delay values when allocating panels to terminals according to the present disclosure.

TABLE 6

| | BWP switch | | panel index |
|---|---|---|---|
| terminal | delay | BWP switch delay index | (3 bits) |
| terminal A | T_BWPswitchDelay A | T_BWPswitchDelay #1 | panel 1 (000) |
| terminal B | T_BWPswitchDelay B | T_BWPswitchDelay #1 | panel 1 (000) |
| terminal C | T_BWPswitchDelay C | T_BWPswitchDelay #2 | panel 2 (001) |
| terminal D | T_BWPswitchDelay D | T_BWPswitchDelay #2 | panel 2 (001) |
| terminal E | T_BWPswitchDelay E | T_BWPswitchDelay #3 | panel 3 (010) |
| terminal F | T_BWPswitchDelay F | T_BWPswitchDelay #3 | panel 3 (010) |
| terminal G | T_BWPswitchDelay G | | |

In Table 6, the BWP switch delay value may be a value set in response to a delay time that occurs when switching from an activated BWP to a new BWP. As in Table 4 and Table 5 described above, seven terminals, including the terminal A, terminal B, terminal C, terminal D, terminal E, terminal F, and terminal G, may be terminals belonging to one group. Here, the group to which the seven terminals belong may be a group of terminals for which the first to third panels satisfy the threshold value or greater, as described in Table 3.

Table 6 shows a BWP switch delay value for a BWP that each terminal wishes to activate, and each value may be a different value. As exemplified in Table 6, the terminal A has a value of T_BWPswitchDelay A, the terminal B has a value of T_BWPswitchDelay B, the terminal C has a value of T_BWPswitchDelay C, the terminal D has a value of T_BWPswitchDelay D, the terminal E has a value of T_BWPswitchDelay E, the terminal F has a value of T_BWPswitchDelay F, and the terminal G has a value of T_BWPswitchDelay G.

T_BWPswitchDelay values may be divided into several time sections. In the example in Table 6, a case where T_BWPswitchDelay values are divided into three time sections is exemplified. It may be assumed that T_BWPswitchDelay #1 is an index for the first time section, T_BWPswitchDelay #2 is an index for the second time section, and T_BWPswitchDelay #3 is an index for the final third time section. When divided into three sections as described above, the index may be determined as 2 bits according to the method of Equation 1 described above.

In the present disclosure, panels may be allocated to the terminal A to terminal G based on the indices divided into three sections. According to the example in Table 6, the base station may allocate the first panel to the terminal A and terminal B because both the terminal A and terminal B have the index T_BWPswitchDelay #1. In addition, the base station may allocate the second panel to the terminal C and terminal D because both the terminal C and terminal D have the index T_BWPswitchDelay #2. Further, the base station may allocate the third panel to the terminal E and terminal F because both the terminal E and terminal F have the index T_BWPswitchDelay #3.

Finally, the terminal G may not be able to operate because there is no panel or BWP switch delay suitable for T_BWPswitchDelay of the terminal G during the panel selection process. Therefore, terminal G may be excluded from panel allocation considering BWP switch delays. For the terminal G, a panel may be selected by considering other schemes, for example, the above-described schemes based on RSRP measurement report, SCS, and/or BWP inactivity timer.

Meanwhile, similarly to the method using SCSs described previously with reference to Table 4, even when using T_BWPswitchDelay, it may be necessary to determine for which subgroup to preferentially select a panel among the first subgroup of terminal A and terminal B, the second subgroup of terminals C and D, and the third subgroup of terminals E and F from the group of terminals A to G. Since the method described above may be used to determine for which of the subgroups to preferentially allocate a panel, similar description thereon will be omitted.

In the above description, four different schemes have been described. To summarize these, the base station may allocate a panel considering only one terminal. In this case, a panel with the highest RSRP may be allocated to the one terminal based on a measurement report of received powers received from the terminal.

In addition, since the base station generally communicates with multiple terminals, measurement reports from other terminals may need to be considered together to use resources more efficiently, that is, to increase panel use efficiency. Accordingly, in the present disclosure, three cases of panel allocation considering a plurality of terminals have been described.

First, the base station may allocate a panel to a terminal by considering an SCS of a BWP to be activated for the terminal. Second, the base station may allocate a panel to a terminal by considering a BWP inactivity timer value of a BWP to be activated for the terminal. Third, the base station may allocate a panel to a terminal by considering a BWP switch delay of a BWP to be activated for the terminal.

The four schemes described above may be operated independently or in combination. For example, in cases where an SCS of a BWP is considered, where a BWP inactivity timer value of a BWP is considered, and where a BWP switch delay of a BWP is considered, the case in which the terminal G is excluded from panel allocation has been described. When a specific panel cannot be allocated to the terminal G, the terminal G may not be able to communicate with the base station. In the present disclosure, the method of allocating a panel to the terminal G by considering RSRP has been described. In addition, the terminal G may be a terminal that satisfies the threshold value or greater for all of the first to fifth panels 321 to 325 illustrated in FIG. 3B. In this case, the terminal G may belong not only to one group but also to other groups. When the terminal G is included in another group, one of the four schemes described above may be applied to the another group.

Therefore, the base station according to the present disclosure does not intend to exclude a specific terminal from communication, but may exclude the specific terminal during the process of finding a suitable panel for the specific terminal.

In addition, a panel may be determined by considering the BWP inactivity timer while considering the SCS, or by considering the BWP switch delay value while considering the SCS. In addition, a panel may be determined by considering all three schemes. Therefore, it should be noted that the examples described in the present disclosure may be replaced by excluding a specific example, but two or more schemes may also be considered together.

In step S540, the second communication device 502 may select the optimal panel based on the schemes described above. That is, the optimal panel for the first communication device 501 may be selected. Here, the optimal panel may be selected as a panel that is optimal for communication from the perspective of the first communication device 501, a panel that is optimal for resource utilization in the second communication device 502, or a panel that is optimal for the perspective of both the first communication device 501 and the second communication device 502,

In step S550, the second communication device 502 may provide a response signal to the first communication device 501. The response signal transmitted from the second communication device 502 to the first communication device 501 in step S550 may be transmitted using at least one among an RRC message, an RRC reconfiguration message, a response message in response to receipt of a measurement report, or a newly defined message to indicate the optimal panel. The messages exemplified in the present disclosure are merely examples to aid understanding, and are not limited thereto. According to an exemplary embodiment of the present disclosure, any message (or signal) for another purpose may be used as long as it can be transmitted by directly or implicitly including the information indicating the optimal panel.

In step S550, the first communication device 501 may receive the response signal transmitted by the second communication device 502. After receiving the response signal, the first communication device 501 may determine a panel to use for communication based on the received response signal in step S560.

In step S570, the second communication device 502 may allocate resources to the first communication device 501, and the first communication device 501 may use the resources allocated by the second communication device 502 to perform uplink and/or downlink communication. In this case, the first communication device 501 may communicate with the second communication device 502 using the panel determined in step S560. In addition, the second communication device 502 may communicate with the first communication device 501 through the panel selected in step S540.

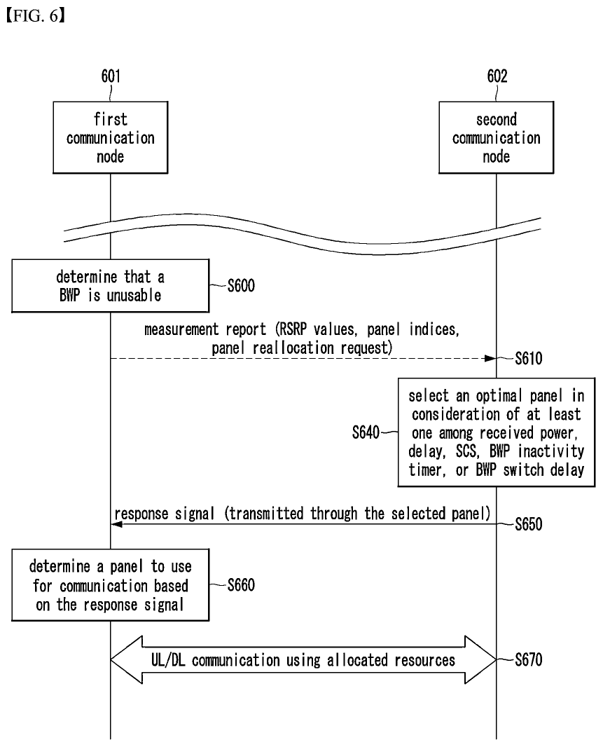

FIG. 6 is a signal flow diagram describing a process for panel and BWP reallocation depending on a channel environment between a terminal and a base station according to an exemplary embodiment of the present disclosure.

As shown in FIG. 6, each of a first communication device 601 and a second communication device 602 may be one of the communication devices 110-1, 110-2, 110-3, 120-1, 120-2, 130-1, 130-2, 103-3, 130-4, 130-5, and 200 previously described in FIGS. 1 and 2. The signal flow illustrated in FIG. 6 may be applied to the NR communication system, an example of 5G communication currently under development, with some services being provided. In addition, it may also be applied to 6G communication, which is expected to use a higher frequency band than the 5G communication in the future. The first communication device 601 and the second communication device 602 described below may both be specific terminals and/or user equipment (UEs). A case where the first communication device 601 and the second communication device 602 are both terminals (or UEs) may correspond to a form of communication without a base station, such as direct communication between devices (D2D), IoT, and/or V2X. The present disclosure may also be applied to such communication schemes between terminals. However, a case where the second communication device 602 is a terminal may correspond to a form of having a multi-panel antenna as previously illustrated in FIG. 3B.

As another example, the first communication device 601 may be a terminal, and the second communication device 602 may be a specific access point (AP). The case where the second communication device 602 is implemented as an AP may also correspond to the form of having a multi-panel antenna as previously illustrated in FIG. 3B.

However, for convenience of description, in the following description, it is assumed that the first communication device 601 is a UE, and the second communication device 602 is a base station. In particular, in the following description, for convenience of description, it is assumed that the second communication device 602 is a gNB, which is a base station according to the NR communication specifications among various base station equipment. Accordingly, in the following description, a gNB may be understood as the second communication device 602.

In step S600, the first communication device 601 may determine that a BWP currently allocated from the second communication device 602 becomes unusable while communicating with the second communication device 602 or while the first communication device 601 is in the inactive state or idle state. Specifically, based on an RSRP threshold set by the base station, the terminal may determine that a corresponding panel and BWP cannot be used when an RSRP of a received signal does not exceed the RSRP threshold.

In step S610, the first communication device 601 may transmit a measurement report to the second communication device 602 based on the determination that the BWP is unusable. In this case, the measurement report may include information on the RSRP values and panel indices as described in FIGS. 4 and 5, and may additionally include a panel reallocation request message according to the present disclosure. The panel reallocation request message may be exemplified as shown in Table 7 below.

TABLE 7

| Panel and BWP | |
|---|---|
| reallocation indicator | Panel and BWP reallocation indication information |
| 0 | New reallocation process is not required |
| 1 | New reallocation process is required |

As exemplified in Table 7, the panel and BWP reallocation indicator may have a value of 0 or 1. As exemplified in Table 7, when the panel and BWP reallocation indicator is set to 0, it may indicate that a new reallocation process is not required, and when the panel and BWP reallocation indicator is set to 1, it may indicate that a new reallocation process is required.

Meanwhile, the measurement report in step S610 may be transmitted through uplink control information (UCI) when the first communication device 601 and the second communication device 602 are communicating. As another example, the measurement report may be transmitted using Measurement Report, UE Assistance Information, or UEInformationResponse defined in an RRC reconfiguration message.

In step S610, the second communication device 602 may identify whether reallocation of a panel and BWP is requested using the panel reallocation request indicator included in the measurement report transmitted by the first communication device 601. When reallocation of a panel and BWP is requested, reallocation of a panel and BWP may be performed in step S640. The reallocation of a panel and BWP may be performed using one of the methods previously described in step S540 of FIG. 5. Activation (or selection) of a new BWP and allocation of a panel performed by the second communication device 602 in step S640 may be described identically to what has been previously described in step S540 of FIG. 5.

When a new BWP and panel are selected in the same manner as the previously described schemes, the second communication device 602 may transmit a response signal to the first communication device 601. In this case, the response signal may be transmitted through the selected panel or through a panel of the currently activated BWP.

In step S650, the first communication device 601 may receive the response signal transmitted by the second communication device 602. After receiving the response signal, the first communication device 601 may determine a panel to be used for communication with based on the received response signal in step S660.

According to an exemplary embodiment of the present disclosure, the response signal including panel information indicating an optimal panel may be transmitted to the first communication device 601 through all panels. According to another exemplary embodiment of the present disclosure, the response signal including the panel information indicating the optimal panel may be transmitted to the first communication device 601 through only the selected panel. According to yet another exemplary embodiment of the present disclosure, the response signal including the panel information indicating the optimal panel may be transmitted to the first communication device 601 through at least one of the selected panel and an arbitrary panel (including the currently communicating panel). According to yet another exemplary embodiment of the present disclosure, the response signal including the panel information indicating the optimal panel may be transmitted to the first communication device 601 through at least one arbitrary panel.

In step S670, the second communication device 602 may allocate resources to the first communication device 601, and the first communication device 601 may use the resources allocated by the second communication device 602 to perform uplink and/or downlink communication. Here, resource allocation information for allocating the resources may be additional information for communication. In this case, the first communication device 601 may communicate with the second communication device 602 through the panel and BWP determined in step S660. In addition, the second communication device 602 may communicate with the first communication device 601 through the panel selected in step S640.

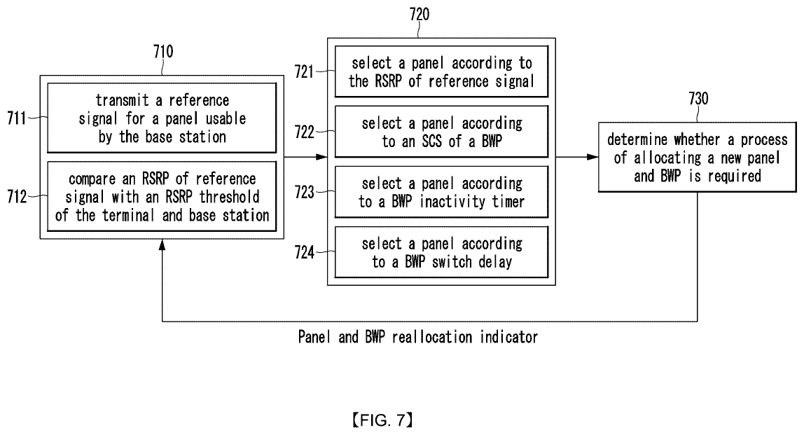

FIG. 7 is a diagram describing a panel and BWP allocation and reallocation procedure according to the present disclosure.

As shown in FIG. 7, step 710 may be a procedure performed at the base station and/or terminal. Specifically, in step 711, the base station may periodically transmit a reference signal including information on a panel index for each available panel. The transmission of the reference signal may correspond to the SSB transmission previously described in FIG. 4. As another example, when the base station communicates with the terminal, the reference signal may be a reference signal used for communication.

In step 712, the terminal may measure the received signal as described in step S420 of FIG. 4 and transmit a measurement report to the base station as in S430 of FIG. 4. Accordingly, the base station may compare an RSRP threshold and an RSRP of the reference signal based on the measurement report. As another example, as previously described in steps S500 and S510 of FIG. 5, the base station may deliver the RSRP threshold in advance and periodically transmit SSBs. In response, the terminal may measure the SSBs and transmit an indicator indicating ‘satisfied’ or ‘dissatisfied’ to the base station based on a result of comparing the previously received RSRP threshold and the measured RSRP.

In step 720, the base station may select a panel to use for communication with the corresponding terminal from among panels included in a multi-panel antenna based on the received comparison result. Specifically, in step 721, the base station may select one panel to be used for communication with the corresponding terminal among the panels included in the multi-panel antenna as described in Table 3 based on the RSRP of the reference signal.

As another example, as described in step 722, one panel may be selected from among the panels included in the multi-panel antenna according to an SCS of a BWP. This may be based on the content previously described in Table 4 of FIG. 5.

As yet another example, in step 723, one panel may be selected from among the panels included in the multi-panel antenna by considering a BWP inactivity timer. This may be based on the content previously described in Table 5 of FIG. 5.

As yet another example, in step 724, one panel may be selected from among the panels included in the multi-panel antenna according to a BWP switch delay. This may be based on the content previously described in Table 6 of FIG. 5.

In steps 721, 722, 723, and 724 illustrated in FIG. 7, one panel may be selected from among the panels included in the multi-panel antenna by considering two or more methods together.

While communicating using the selected panel, it may be identified whether a new panel and BWP allocation process is required as in step 730. This may be the procedure previously described in FIG. 6. If allocation of a new panel and BWP is required, the terminal may generate a panel and BWP reallocation indicator and transmit it to the base station. Then, steps 711 and/or 712 may be performed.

The procedure for selecting one panel from among the panels included in the multi-panel antenna according to the present disclosure has been described through the forms described above. However, communication may need to be performed by selecting one panel from among the panels included in the multi-panel antenna of the base station depending on other conditions in addition to the conditions of cases described above. In this case, the features of the present disclosure may be applied according to each condition.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

### INDUSTRIAL APPLICABILITY

The present disclosure can be applied when selecting an antenna panel in a system with a multi-panel antenna.

1. A method of a first user equipment (UE), comprising:
transmitting a reference signal at a predetermined periodicity through each of panels included in a multi-panel antenna of the first UE, the reference signal including each panel index;
receiving a measurement report corresponding to each of the panels from a second user equipment (UE), the measurement report including a panel index and a received signal received power value of the reference signal corresponding to the panel index;
selecting a panel to be allocated to the second UE based on the measurement report; and
transmitting a response signal including information on the selected panel to the second UE.

2. The method according to claim 1, wherein the response signal is transmitted through all panels included in the multi-panel antenna, a panel selected based on the measurement report among the panels included in the multi-panel antenna, at least one panel selected among the selected panel and an arbitrary panel, or at least one arbitrary panel.

3. The method according to claim 1, wherein the response signal is one of a radio resource control (RRC) message, an RRC reconfiguration message, or a response message corresponding to the measurement report.

4. The method according to claim 1, wherein in the selecting of the panel to be allocated to the second UE, the panel is selected considering measurement information received from a third user equipment (UE) and a subcarrier spacing (SCS) to be used for communication of the second communication node and the third UE.

5. The method according to claim 1, wherein in the selecting of the panel to be allocated to the second UE, the panel is selected considering measurement information received from a third user equipment (UE) and a bandwidth part (BWP) inactivity timer value to be used for communication of the second UE and the third UE.

6. The method according to claim 1, wherein in the selecting of the panel to be allocated to the second UE, the panel is selected considering measurement information received from a third user equipment (UE) and a BWP switch delay value to be used for communication of the second UE and the third UE.

7. The method according to claim 1, wherein in the selecting of the panel to be allocated to the second UE, the panel is selected considering two or more among measurement information received from a third user equipment (UE), an SCS to be used for communication of the second UE and the third UE, or a BWP inactivity timer value or a BWP switch delay value to be used for communication of the second UE and the third UE.

8. The method according to claim 1, further comprising: in response to receiving, from the second UE, a measurement report including a reallocation request indicator indicating whether new reallocation process is required for either an allocated BWP or the selected panel while communicating with the second UE through the allocated BWP and the selected panel, or for both of the allocated BMP and the selected panel, reselecting a panel to use for communication based on the panel index and the received signal receiver power value of the reference signal corresponding to the panel index, which are included in the received measurement report.

9. A first user equipment (UE) comprising:
a transceiver configured to transmit and receive signals with at least one second user equipment (UE); and
at least one processor,
wherein the at least one processor is executed to:
control the transceiver to transmit a reference signal at a predetermined periodicity through each of panels included in a multi-panel antenna of the first UE, the reference signal including each panel index;
control the transceiver to receive a measurement report corresponding to each of the panels from the at least one second UE, the measurement report including a panel index and a received signal received power value of the reference signal corresponding to the panel index;
select a panel to be allocated to the at least one second UE based on the measurement report; and
control the transceiver to transmit a response signal including information on the selected panel to the at least one second UE.

10. The first UE according to claim 9, wherein the response signal is transmitted through all panels included in the multi-panel antenna, a panel selected based on the measurement report among the panels included in the multi-panel antenna, at least one panel selected among the selected panel and an arbitrary panel, or at least one arbitrary panel.

11. The first UE according to claim 9, wherein the response signal is one of a radio resource control (RRC) message, an RRC reconfiguration message, or a response message corresponding to the measurement report.

12. The first UE according to claim 9, wherein the at least one processor is executed to, in the selecting of the panel to be allocated to the second UE, select the panel considering measurement information received from a third user equipment (UE) and a subcarrier spacing (SCS) to be used for communication of the second UE and the third UE.

13. The first UE according to claim 9, wherein the at least one processor is executed to, in the selecting of the panel to be allocated to the second UE, select the panel considering measurement information received from a third user equipment (UE) and a bandwidth part (BWP) inactivity timer value to be used for communication of the second UE and the third UE.

14. The first UE according to claim 9, wherein the at least one processor is executed to, in the selecting of the panel to be allocated to the second UE, select the panel considering measurement information received from a third user equipment (UE) and a BWP switch delay value to be used for communication of the second UE and the third UE.

15. The first UE according to claim 9, wherein the at least one processor is executed to, in the selecting of the panel to be allocated to the second UE, select the panel considering two or more among measurement information received from a third user equipment (UE), an SCS to be used for communication of the second UE and the third UE, or a BWP inactivity timer value or a BWP switch delay value to be used for communication of the second UE and the third UE.

16. The first UE according to claim 9, wherein the at least one processor is executed to, in response to receiving, from the second UE, a measurement report including a reallocation request indicator for an allocated BWP and/or the selected panel while communicating with the second UE through the allocated BWP and the selected panel, reselect a panel to use for communication based on the panel index and the received signal receiver power value of the reference signal corresponding to the panel index, which are included in the received measurement report.

17. A method of a first user equipment (UE), comprising:
receiving a reference signal at a predetermined periodicity through each of panels included in a multi-panel antenna of a second user equipment (UE) to communicate, the reference signal including each panel index;
measuring a received power for the reference signal received through each of the panels;
transmitting, to the second UE, a measurement report including an index of each of the panels and information on the received power corresponding to each of the panels;
receiving, from the second UE, information on a selected panel in response to the measurement report;
obtaining additional information for communicating with the second UE through the selected panel; and
communicating with the second UE using the selected panel and the additional information.

18. The method according to claim 17, wherein the additional information includes information on a bandwidth part (BWP) to be used for communication with the second UE through the selected panel.

19. The method according to claim 18, further comprising:
measuring a received power for the reference signal received through each of the panels when the BWP to be used for communication with the second UE is unusable; and
transmitting a second measurement report including an indicator requesting reallocation of a BWP and/or panel to the second UE.

20. The method according to claim 19, further comprising:
receiving, from the second UE, information on a changed panel and BWP reallocation information; and
communicating with the second UE based on the information on the changed panel and the BWP reallocation information.
